(19) United States
(12) Patent Application Publication
(10) Pub. No.: US 2025/0068884 A1
(43) Pub. Date: Feb. 27, 2025

(54) Anomaly detection model training method, anomaly detection methods, and load detection devices for household electricity

(71) Applicant: INSTITUTE FOR INFORMATION INDUSTRY, Taipei (TW)

(72) Inventors: Kuang Ping Tseng, Taipei (TW); Wen Jen Ho, Taipei (TW); Chia Wei Tsai, Taipei (TW); Kuei Chun Chiang, Taipei (TW); Yung Chieh Hung, Taipei (TW)

(21) Appl. No.: 18/378,665

(22) Filed: Oct. 11, 2023

(30) Foreign Application Priority Data
Aug. 22, 2023 (TW) 112131489

(51) Int. Cl. G06N 3/045; G06N 3/084

(52) U.S. Cl. CPC G06N 3/045; G06N 3/084

(57) ABSTRACT

An anomaly detection model training method, anomaly detection methods, and load detection devices for household electricity are provided. The anomaly detection method is applied to the load detection device, which includes a processing unit and an anomaly detection model. The processing unit trains the anomaly detection model and performs an anomaly detection method. The anomaly detection method includes: extracting user electrical features to obtain feature data; grouping the feature data based on electricity consumption behavior and inputting them into the first and second single classification models respectively to generate detection results corresponding to the first and second single classification models; generating anomaly electricity detection results based on the detection results; differentiating the electricity load data according to unit time to become a plurality segments of sub-electricity load data; and comparing the segments of sub-electricity load data with the historical load data to output a plurality of anomaly electricity consumption periods.

### FIELD OF THE INVENTION

The present invention relates to the technical field of non-invasive load monitoring, and particularly relates to anomaly detection model training method, anomaly detection methods, and load detection devices for household electricity.

### BACKGROUND OF THE INVENTION

In current technology, abnormal detection for electricity consumption often requires pre-defining anomaly sample data (that is, defining electricity consumption anomalies first), then collecting relevant electricity consumption data, and then comparing the anomaly sample data with normal sample data, thereby training the load model and detecting whether electricity consumption anomalies occur in the user's electricity consumption behavior.

However, in practical cases, anomaly electricity consumption does not occur frequently, so the collection of anomaly samples is not easy and it is difficult to ensure the integrity of the collected anomaly electricity consumption data. Therefore, the current technology for electricity consumption anomaly detection is not reliable, and its applicability is also limited due to the collection of anomaly sample data therefore it cannot be widely used in various electricity consumption scenarios (the current usage scenario of electricity consumption anomaly detection must correspond to the collected abnormal sample data).

### SUMMARY OF THE INVENTION

Therefore, the present invention provides an anomaly detection model training method for household electricity and applied to a load detection device. The load detection device includes a processing unit and a storage unit. The storage unit is coupled to the processing unit. The storage unit stores an anomaly detection model. The anomaly detection model includes a first group of single classification models and a second group of single classification models. The anomaly detection model training method performs a training process on the anomaly detection model with the processing unit. The training process comprises the following steps: obtaining historical load data of a user and performing electricity feature extraction to obtain feature data; grouping the feature data to generate a first electricity consumption behavior group and a second electricity consumption behavior group; filtering the first electricity consumption behavior group and the second electricity consumption behavior group based on an anomaly threshold to generate a first normal electricity consumption data corresponding to the first electricity consumption behavior group, a second normal electricity consumption data corresponding to the second electricity consumption behavior group, and an electricity noise data, wherein the first normal electricity consumption data and the second normal electricity consumption data do not have the electricity noise data; in a training step, inputting the first normal electricity consumption data and the second normal electricity consumption data to the first group of single classification models and the second group of single classification models for training; in a verification step, inputting the first normal electricity consumption data, the second normal electricity consumption data, and the electricity noise data to the first group of single classification models and the second group of single classification models to generate detection results corresponding to the first group of single classification models and the second group of single classification models; and storing the anomaly detection model in the storage unit when the detection results are all greater than a preset anomaly detection value.

The present invention further provides an anomaly detection method for household electricity and applied to a load detection device. The load detection device includes a processing unit and a storage unit. The storage unit is coupled to the processing unit. The storage unit stores an anomaly detection model. The anomaly detection model includes a first group of single classification models and a second group of single classification models. The processing unit performs the anomaly detection method, and the anomaly detection method includes the following steps: obtaining historical load data of a user and performing electricity feature extraction to obtain feature data; grouping the feature data to generate a first electricity consumption behavior group and a second electricity consumption behavior group; inputting the first electricity consumption behavior group and the second electricity consumption behavior group to the first group of single classification models and the second group of single classification models to generate the detection results corresponding to the first group of single classification models and the second group of single classification models, respectively; inputting the detection results into an integration layer network to generate an anomaly electricity detection result; differentiating, based on the anomaly electricity detection results, the electricity load data of the user according to unit time to become a plurality segments of sub-electricity load data; and comparing each of the segments of sub-electricity load data with the historical load data of the user to output a plurality of anomaly electricity consumption periods.

The present invention further provides a load detection device for household electricity. The load detection device includes a processing unit and a storage unit. The storage unit is coupled to the processing unit. The storage unit stores an anomaly detection model. The anomaly detection model includes a first group of single classification models and a second group of single classification models. The processing unit performs an anomaly detection method, and the anomaly detection method includes the following steps: obtaining historical load data of a user and performing electricity feature extraction to obtain feature data; grouping the feature data to generate a first electricity consumption behavior group and a second electricity consumption behavior group; inputting the first electricity consumption behavior group and the second electricity consumption behavior group to the first group of single classification models and the second group of single classification models to generate the detection results corresponding to the first group of single classification models and the second group of single classification models, respectively; inputting the detection results into an integration layer network to generate an anomaly electricity detection result; differentiating, based on the anomaly electricity detection results, the electricity load data of the user according to unit time to become a plurality segments of sub-electricity load data; and comparing each of the segments of sub-electricity load data with the historical load data of the user to output a plurality of anomaly electricity consumption periods.

With the technical architecture of the present invention, it is only necessary to collect the user's historical load data to analyze and train the anomaly detection model. Therefore, even if abnormal samples are not collected for training, the anomaly detection model still has reliability and wide applicability. Moreover, the abnormality detection model of the present invention inputs the grouped normal electricity consumption data into two different single classification models in parallel through holistic learning, thus improving the accuracy of abnormality detection. In addition, through the two-stage anomaly detection process of the present invention, the anomaly detection is performed in the first stage, and time-by-time detection and comparison are performed in the second stage to find the abnormal time period. In this way, abnormal power consumption of the load can be identified for subsequent home monitoring and care services.

### BRIEF DESCRIPTION OF THE DRAWINGS

FIG. 1 is a block diagram of a load detection device provided in an embodiment of the present invention;

FIG. 2 is a flowchart of a training process provided in an embodiment of the present invention;

FIG. 3 is a flowchart of the steps of an anomaly detection method provided in an embodiment of the present invention; and

FIG. 4 is a schematic diagram of a training process provided by an embodiment of the present invention.

### DETAILED DESCRIPTION OF PREFERRED EMBODIMENTS

Terms used in the description of the embodiments of the present invention, for example, orientation or position relation such as “above” and “below” are described according to the orientation or position relation shown in the drawings. The above terms are used for facilitating description of the present invention rather than limiting the present invention, i.e., indicating or implying that the mentioned elements have to have specific orientations and to be configured in the specific orientations. In addition, terms such as “first” and “second” involved in the description or claims are merely used for naming the elements or distinguishing different embodiments or ranges rather than limiting the upper limit or lower limit of the quantity of the elements.

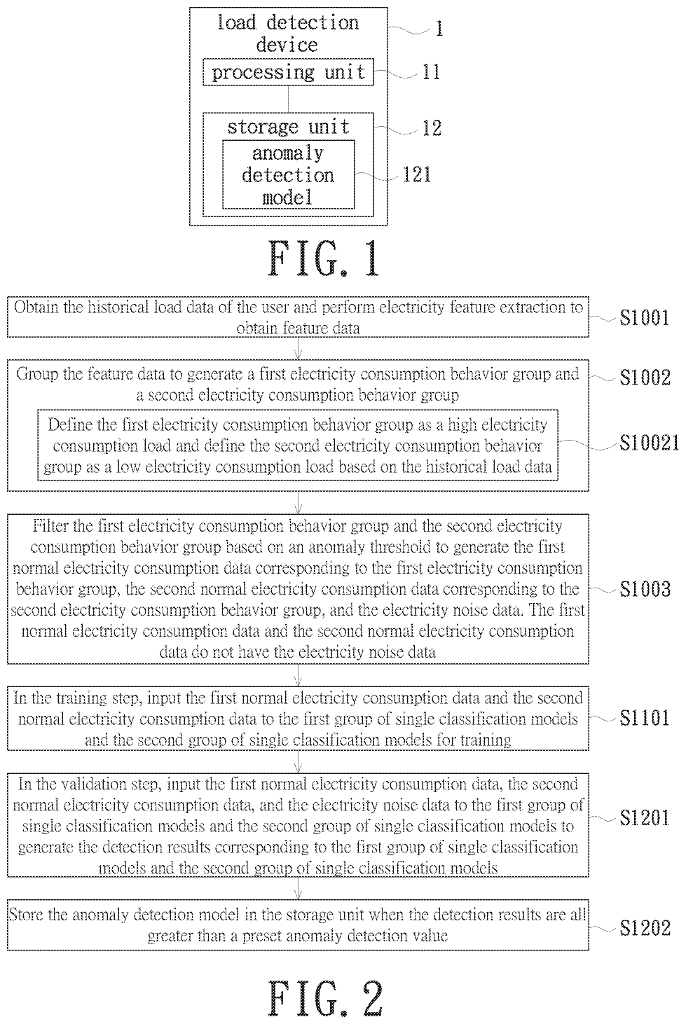

Please refer to FIG. 1. FIG. 1 is a block diagram of a load detection device 1 provided in an embodiment of the present invention.

In this embodiment, the load detection device 1 of the present invention includes a processing unit 11 and a storage unit 12. The storage unit 12 stores an anomaly detection model 121. The anomaly detection model 121 includes a first group of single classification models 121a and a second group of single classification models 121b. The processing unit 11 is coupled to the storage unit 12. In this embodiment, the first group of single classification models 121a and the second group of single classification models 121b can be OCSVM (one-class SVM) models and isolation forest models, respectively. The first group of single classification models 121a and the second group of single classification models 121b can also be other single classification models, such as support vector domain description (SVDD), one-class mini-max probability machine (OCMPM), generalized one-class discriminative sub-spaces (GODS), etc., as long as the first group of single classification models 121a and the second group of single classification models 121b are different single classification models, and the present invention is not limited to this.

The processing unit 11 can be a logic circuit, processor, single-chip microcomputer, and other devices with processing, calculation, timing, and other functions. The types of the processing unit 11 listed are only examples, and the processing unit 11 is not limited to the types of devices listed. All devices with the same function can be used as the processing unit 11 of the present invention.

The storage unit 12 can be a non-volatile memory, memory card, register, etc., or other devices with the same function. The types of storage devices listed are only examples, and the present invention is not limited thereto. All storage devices with the same function can be used as the storage unit 12 of the present invention.

In this embodiment, the load detection device 1 of the present invention can monitor the electrical load data of household users in a non-invasive manner (e.g., it can be arranged on the power loop of a distribution board or electrical appliance and obtain the electrical load data through the sensing loop (not shown) of the load detection device 1). The anomaly detection model training method and anomaly detection method for household electricity consumption provided in this embodiment are applied to the load detection device 1. The anomaly detection model training method includes training the anomaly detection model 121 with the processing unit 11. The following will explain the training process.

Please refer to FIG. 2. FIG. 2 is a flowchart of a training process provided in an embodiment of the present invention. The training process includes training steps and verification steps, which are implemented as follows.

Step S1001: Obtain the historical load data of the user and perform electricity feature extraction to obtain feature data. The processing unit 11 can obtain the user's historical load data, which includes a plurality of load amounts and time series. The load amount can be the current instantaneous load amount of the power loop, and the instantaneous load amount corresponds to the current time point and is recorded (i.e., timestamp, the load amount corresponds to the time series and is recorded). The historical load data does not include anomaly sample data, that is, in the anomaly detection model training method, anomaly detection method, and load detection device of the present invention, there is no collection of anomaly samples (i.e., when training the anomaly detection model, the training data used does not include anomaly samples). Next, the processing unit 11 can extract electricity consumption features from the user's historical load data (i.e., observe and establish past electricity consumption patterns). For example, the processing unit 11 can perform discrete wavelet transform (DWT) on the user's historical load data, perform a filter transform with the orthogonal Daubechies wavelet coefficient db4, and then convert the unit from watts (W) to kilowatts (kW) to obtain lower order feature data (one embodiment of feature data, low-order feature data is smoother than the historical load data (raw data), but the overall data volume remains unchanged), and then convert the low-order feature data into high-order feature data through principal component analysis (PCA) (in one embodiment of feature data, the high-order feature data has a more streamlined data volume compared to low-order feature data).

Step S1002: Group the feature data to generate a first electricity consumption behavior group and a second electricity consumption behavior group. Step S1002 further includes step S10021: Define the first electricity consumption behavior group as a high electricity consumption load and define the second electricity consumption behavior group as a low electricity consumption load based on the historical load data.

In steps S1002 and S10021, the processing unit 11 can divide the feature data into a first electricity consumption behavior group and a second electricity consumption behavior group based on the user's electricity consumption behavior. For example, when a user is a household user, it can be assumed that their electricity consumption is related to the working day. That is, when a household user is on a working day, their electricity consumption should be lower compared to non-working days. However, whether it is a working day or a non-working day, their electricity consumption mode belongs to the normal electricity consumption mode of the household user rather than anomaly electricity consumption. Therefore, the first electricity consumption behavior group can be defined as a high electricity consumption load (e.g., non-working days), and the second electricity consumption behavior group can be defined as a low electricity consumption load (e.g., working days). Because of the high similarity of data between the first electricity consumption behavior group and the second electricity consumption behavior group, it is excluded that the general power consumption is regarded as anomaly power consumption due to different living habits. In other embodiments, the first electricity consumption behavior group and the second electricity consumption behavior group can also be grouped based on the number of electrical appliances, population, and age group of the household user, and the present invention is not limited to this.

Step S1003: Filter the first electricity consumption behavior group and the second electricity consumption behavior group based on an anomaly threshold to generate the first normal electricity consumption data D1 corresponding to the first electricity consumption behavior group, the second normal electricity consumption data D2 corresponding to the second electricity consumption behavior group, and the electricity noise data. The first normal electricity consumption data D1 and the second normal electricity consumption data D2 do not have the electricity noise data. The anomaly threshold refers to the threshold used to remove the extreme values from the feature data. Because the present invention does not require the pre-definition of anomaly samples, removing the extreme values from the feature data can make the training results closer to the user's normal electricity consumption mode. For example, the local outlier factor (LOF) algorithm can be used to filter the first electricity consumption behavior group and the second electricity consumption behavior group. The data with relatively distant regional density (e.g., 4.7%) in the first electricity consumption behavior group and the second electricity consumption behavior group can be used as the electricity noise data, and the remaining data can be used as the noise-free electricity consumption behavior data, thereby generating the first normal electricity consumption data D1 corresponding to the first electricity consumption behavior group, the second normal electricity consumption data D2 corresponding to the second electricity consumption behavior group, and the electricity noise data. In one embodiment, the density of feature data can also be calculated based on Euclidean Distance, and the feature data below the density threshold can be considered as the electrical noise data.

Step S1101: In the training step, input the first normal electricity consumption data D1 and the second normal electricity consumption data D2 to the first group of single classification models 121a and the second group of single classification models 121b for training. In this embodiment, the noise-free electricity consumption behavior data (the first normal electricity consumption data D1 and the second normal electricity consumption data D2) can be extracted, with 80% as the training set, 10% as the validation set, and 10% as the test set, and used for training, validating, and testing the first group of single classification models 121a and the second group of single classification models 121b, respectively. Preferably, the correspondence between the training set, validation set, test set, noise-free electricity consumption behavior data, and noise electricity consumption behavior data can be implemented as follows: training set: 80% of noise-free electricity consumption behavior data; verification set: 10% of noise-free electricity consumption behavior data+50% of noise electricity consumption behavior data (labeled as anomaly electricity consumption behavior); and test set: 10% of noise-free electricity consumption behavior data+50% of noise electricity consumption behavior data (labeled as anomaly electricity consumption behavior).

Please refer to FIG. 4. In this embodiment, the first group of single classification models 121a has two first groups of single classification sub-models 1211a and 1212a of the same model category, correspondingly receiving the first normal electricity consumption data D1 and the second normal electricity consumption data D2, respectively. The second group of single classification models 121b has two second groups of single classification sub-models 1211b and 1212b of the same model category, correspondingly receiving the first normal electricity consumption data D1 and the second normal electricity consumption data D2, respectively, thereby training the anomaly detection model.

Step S1201: In the validation step, input the first normal electricity consumption data D1, the second normal electricity consumption data D2, and the electricity noise data to the first group of single classification models 121a and the second group of single classification models 121b to generate the detection results corresponding to the first group of single classification models 121a and the second group of single classification models 121b. In this embodiment, as described above, the validation set is composed of the first normal electricity consumption data D1, the second normal electricity consumption data D2, and the electricity noise data. In order to input the validation set for validation, one of the first groups of single classification sub-models 1211a receives the first normal electricity consumption data D1 and the electricity consumption noise data, and the other of the first group of single classification sub-models 1211a receives the second normal electricity consumption data D2 and the electricity consumption noise data, one of the second group of single classification sub-models 1211b receives the first normal electricity consumption data D1 and the electricity consumption noise data, and the other of the second group of single classification sub-models 1211b receives the second normal electricity consumption data D2 and the electricity consumption noise data. That is, the validation set is inputted to the first groups of single classification sub-models 1211a, 1212a of the first group of single classification models 121a and the second group of single classification sub-models 1211b and 1212b of the second group of single classification models 121b to respectively generate the detection results.

Next, the detection results generated by the first groups of single classification sub-models 1211a, 1212a of the first group of single classification models 121a and the second groups of single classification sub-models 1211b and 1212b of the second group of single classification models 121b are set with an anomaly detection value based on F1-score to perform model parameter adjustment on the first groups of single classification sub-models 1211a, 1212a and the second groups of single classification sub-models 1211b and 1212b. If the F1-score of one of the detection results is lower than the anomaly detection value, the process can return to the training step for retraining.

Step S1202: Store the anomaly detection model in the storage unit 12 when the detection results are all greater than a preset anomaly detection value. That is, if the F1-scores of these detection results are all greater than the anomaly detection value, the training is regarded as being completed, and the anomaly detection model 121 is stored in the storage unit 12.

Next, the following describes the steps and flow of the processing unit 11 executing the anomaly detection method. In the anomaly detection method, there are steps similar/identical to the training process mentioned above. These steps can be combined and applied as long as there are no conflicts between each step. The implementation details that have been explained will not be repeated here. Only the implementation details that have not been explained will be supplemented, and the following implementation examples will be provided.

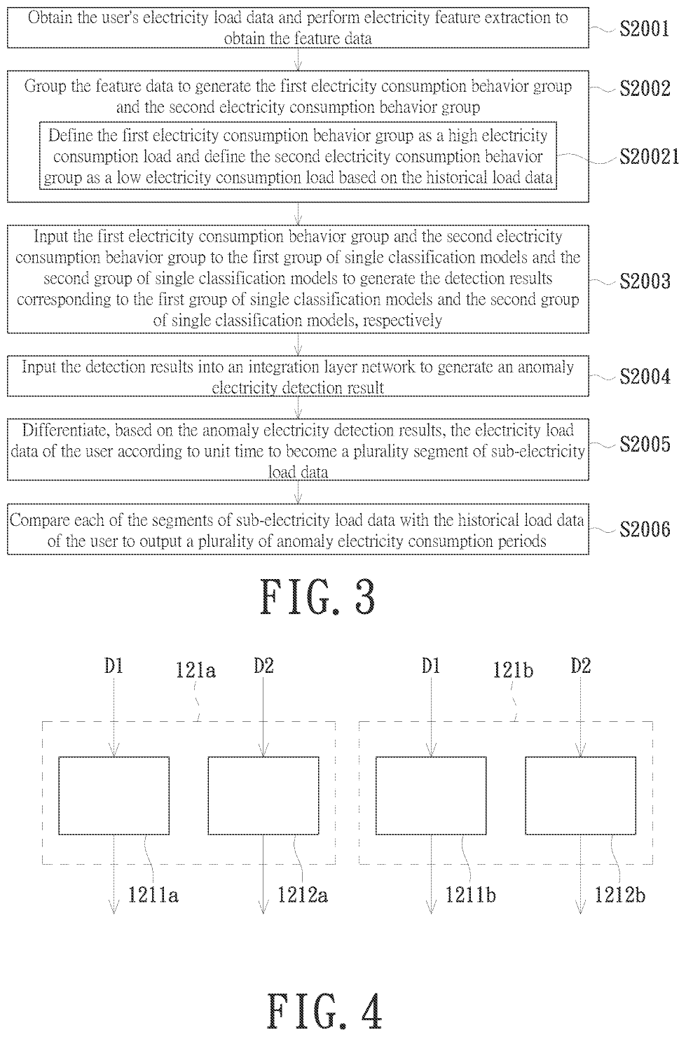

Please refer to FIG. 3. FIG. 3 is a flowchart of the steps of an anomaly detection method provided in an embodiment of the present invention. The anomaly detection method is executed by the processing unit 11 of the load detection device 1 based on the anomaly detection model 121 stored in the storage unit 12. The anomaly detection model 121 has completed training, and the anomaly detection method includes the following steps.

Step S2001: Obtain the user's electricity load data and perform electricity feature extraction to obtain the feature data.

Step S2002: Group the feature data to generate the first electricity consumption behavior group and the second electricity consumption behavior group.

Step S2002 further includes step S20021: Define the first electricity consumption behavior group as a high electricity consumption load and define the second electricity consumption behavior group as a low electricity consumption load based on the historical load data.

Step S2003: Input the first electricity consumption behavior group and the second electricity consumption behavior group to the first group of single classification models 121a and the second group of single classification models 121b to generate the detection results corresponding to the first group of single classification models 121a and the second group of single classification models 121b, respectively. Preferably, the first group of single classification models 121a has two first groups of single classification sub-models with the same model category, correspondingly receiving the first electricity consumption behavior group and the second electricity consumption behavior group, and the second group of single classification models 121b has two second group of single classification sub-models with the same model category, correspondingly receiving the first electricity consumption behavior group and the second electricity consumption behavior group, respectively. This step is illustrated in FIG. 4 and no redundant detail is to be given herein.

Step S2004: I2005. In this step, for example, the first group of single classification models 121a and the second group of single classification models 121b can be combined through ensemble learning, and the anomaly detection weights of the first group of single classification models 121a and the second group of single classification models 121b can be adjusted through the integration layer network to generate the anomaly electricity detection result. In this embodiment, the integration layer network is a backpropagation neural network.

In one embodiment, the integration layer network includes an input layer, an output layer, and an expert weight layer connected between the input layer and the output layer. The first detection result and the second detection result are transmitted to the expert weight layer through the input layer, and the expert weight layer generates a first product of the first detection result and its corresponding weight value, as well as a second product of the second detection result and its corresponding weight value, respectively. The output layer integrates the first product and the second product and then outputs an anomaly electricity detection result.

Preferably, the integrated layer network is a backpropagation neural network that can first integrate the data intervals of the first detection result and the second detection result through the neural network, for example, using the tanh excitation function to set values between −1 and 1. It is considered normal when the value is less than 0, and anomaly when the value is greater than 0. Next, before outputting the anomaly electricity detection result, the first detection result and the second detection result are sent to the integration layer network for anomaly electricity detection result, and the difference between the anomaly electricity detection result and the first and second detection results is calculated. Then, the corresponding weight values of the first and second detection results will be recalculated based on the difference calculated above until the integration layer network reaches stability. Therefore, by repeatedly adjusting the weight of the integrated layer network, the anomaly detection models can be made more reliable and widely applicable.

Step S2005: Differentiate, based on the anomaly electricity detection results, the electricity load data of the user according to unit time to become a plurality segment of sub-electricity load data.

Step S2006: Compare each of the segments of sub-electricity load data with the historical load data of the user to output a plurality of anomaly electricity consumption periods.

In steps S2005 and S2006, for example, the electricity load data (e.g., anomaly data) can be divided into a plurality of subsets based on the anomaly electricity detection results by time period, and statistics can be made with the historical load data frame by frame (e.g., using a standardized score (also known as z-score) for statistics), and each of the plurality segments of sub-electricity load data is compared with the user's historical load data to output the anomaly electricity consumption period (which can be a plurality of anomaly electricity consumption periods) that deviates the farthest from the normal electricity consumption mode.

In summary, with the technical architecture of the present invention, it is only necessary to collect the user's historical load data to analyze and train the anomaly detection model. Therefore, even if abnormal samples are not collected for training, the anomaly detection model still has reliability and wide applicability. Moreover, the abnormality detection model of the present invention inputs the grouped normal electricity consumption data into two different single classification models in parallel through holistic learning, thus improving the accuracy of abnormality detection. In addition, through the two-stage anomaly detection process of the present invention, the anomaly detection is performed in the first stage, and time-by-time detection and comparison are performed in the second stage to find the abnormal time period. In this way, abnormal power consumption of the load can be identified for subsequent home monitoring and care services.

What is claimed is:

1. An anomaly detection model training method for household electricity, applied to a load detection device, wherein the load detection device comprises a processing unit and a storage unit, the storage unit is coupled to the processing unit, the storage unit stores an anomaly detection model, the anomaly detection model comprises a first group of single classification models and a second group of single classification models, the anomaly detection model training method performs a training process on the anomaly detection model with the processing unit, the training process comprises the following steps:
obtaining historical load data of a user and performing electricity feature extraction to obtain feature data;
grouping the feature data to generate a first electricity consumption behavior group and a second electricity consumption behavior group;
filtering the first electricity consumption behavior group and the second electricity consumption behavior group based on an anomaly threshold to generate a first normal electricity consumption data corresponding to the first electricity consumption behavior group, a second normal electricity consumption data corresponding to the second electricity consumption behavior group, and an electricity noise data, wherein the first normal electricity consumption data and the second normal electricity consumption data do not have the electricity noise data;
training step, inputting the first normal electricity consumption data and the second normal electricity consumption data to the first group of single classification models and the second group of single classification models for training;
verification step, inputting the first normal electricity consumption data, the second normal electricity consumption data, and the electricity noise data to the first group of single classification models and the second group of single classification models to generate detection results corresponding to the first group of single classification models and the second group of single classification models; and
storing the anomaly detection model in the storage unit when the detection results are all greater than a preset anomaly detection value.

2. The anomaly detection model training method according to claim 1, wherein the step of grouping the feature data comprises:
defining the first electricity consumption behavior group as a high electricity consumption load and defining the second electricity consumption behavior group as a low electricity consumption load based on the historical load data.

3. The anomaly detection model training method according to claim 1, wherein in the training step, the first group of single classification models has two first groups of single classification sub-models of the same model category, correspondingly receiving the first normal electricity consumption data and the second normal electricity consumption data, respectively, and the second group of single classification models has two second groups of single classification sub-models of the same model category, correspondingly receiving the first normal electricity consumption data and the second normal electricity consumption data, respectively.

4. The anomaly detection model training method according to claim 3, wherein in the verification step, one of the first groups of single classification sub-models receives the first normal electricity consumption data and the electricity consumption noise data, and the other of the first group of single classification sub-models receives the second normal electricity consumption data and the electricity consumption noise data, one of the second groups of single classification sub-models receives the first normal electricity consumption data and the electricity consumption noise data, and the other of the second group of single classification sub-models receives the second normal electricity consumption data and the electricity consumption noise data.

5. The anomaly detection model training method according to claim 1, wherein the first group of single classification models and the second group of single classification models are a one-class SVM (OCSVM) model and an isolation forest model, respectively.

6. An anomaly detection method for household electricity, applied to a load detection device, wherein the load detection device comprises a processing unit and a storage unit, the storage unit is coupled to the processing unit, the storage unit stores an anomaly detection model, the anomaly detection model comprises a first group of single classification models and a second group of single classification models, the processing unit performs the anomaly detection method, and the anomaly detection method comprises the following steps:
obtaining historical load data of a user and performing electricity feature extraction to obtain feature data;
grouping the feature data to generate a first electricity consumption behavior group and a second electricity consumption behavior group;
inputting the first electricity consumption behavior group and the second electricity consumption behavior group to the first group of single classification models and the second group of single classification models to generate the detection results corresponding to the first group of single classification models and the second group of single classification models, respectively;
inputting the detection results into an integration layer network to generate an anomaly electricity detection result;
differentiating, based on the anomaly electricity detection results, the electricity load data of the user according to unit time to become a plurality segments of sub-electricity load data; and
comparing each of the segments of sub-electricity load data with the historical load data of the user to output a plurality of anomaly electricity consumption periods.

7. The anomaly detection method according to claim 6, wherein the step of grouping the feature data comprises:
defining the first electricity consumption behavior group as a high electricity consumption load and defining the second electricity consumption behavior group as a low electricity consumption load based on the historical load data.

8. The anomaly detection method according to claim 6, wherein the first group of single classification models has two first groups of single classification sub-models of the same model category, correspondingly receiving the first electricity consumption behavior group and the second electricity consumption behavior group, respectively, and the second group of single classification models has two second groups of single classification sub-models of the same model category, correspondingly receiving the first electricity consumption behavior group and the second electricity consumption behavior group, respectively.

9. The anomaly detection method according to claim 6, wherein the first group of single classification models and the second group of single classification models are a one-class SVM (OCSVM) model and an isolation forest model, respectively.

10. The anomaly detection method according to claim 6, wherein the integration layer network comprises an input layer, an output layer, and an expert weight layer connected between the input layer and the output layer, the first detection result and the second detection result are transmitted to the expert weight layer through the input layer, the expert weight layer generates a first product of the first detection result and its corresponding weight value, as well as a second product of the second detection result and its corresponding weight value, respectively, and the output layer integrates the first product and the second product and then outputs an anomaly electricity detection result.

11. The anomaly detection method according to claim 6, wherein the integrated layer network is a backpropagation neural network.

12. A load detection device for household electricity, comprising:
a processing unit; and
a storage unit, coupled to the processing unit, wherein the storage unit stores an anomaly detection model, and the anomaly detection model comprises a first group of single classification models and a second group of single classification models;
wherein the processing unit performs an anomaly detection method, and the anomaly detection method comprises the following steps:
obtaining historical load data of a user and performing electricity feature extraction to obtain feature data;
grouping the feature data to generate a first electricity consumption behavior group and a second electricity consumption behavior group;
inputting the first electricity consumption behavior group and the second electricity consumption behavior group to the first group of single classification models and the second group of single classification models to generate the detection results corresponding to the first group of single classification models and the second group of single classification models, respectively;
inputting the detection results into an integration layer network to generate an anomaly electricity detection result;
differentiating, based on the anomaly electricity detection results, the electricity load data of the user according to unit time to become a plurality segments of sub-electricity load data; and
comparing each of the segments of sub-electricity load data with the historical load data of the user to output a plurality of anomaly electricity consumption periods.

13. The load detection device according to claim 12, wherein the step of grouping the feature data comprises:
defining the first electricity consumption behavior group as a high electricity consumption load and defining the second electricity consumption behavior group as a low electricity consumption load based on the historical load data.

14. The load detection device according to claim 12, wherein the first group of single classification models has two first groups of single classification sub-models of the same model category, correspondingly receiving the first electricity consumption behavior group and the second electricity consumption behavior group, respectively, and the second group of single classification models has two second groups of single classification sub-models of the same model category, correspondingly receiving the first electricity consumption behavior group and the second electricity consumption behavior group, respectively.

15. The load detection device according to claim 12, wherein the first group of single classification models and the second group of single classification models are a one-class SVM (OCSVM) model and an isolation forest model, respectively.

16. The load detection device according to claim 12, wherein the integration layer network comprises an input layer, an output layer, and an expert weight layer connected between the input layer and the output layer, the first detection result and the second detection result are transmitted to the expert weight layer through the input layer, the expert weight layer generates a first product of the first detection result and its corresponding weight value, as well as a second product of the second detection result and its corresponding weight value, respectively, and the output layer integrates the first product and the second product and then outputs an anomaly electricity detection result.

17. The load detection device according to claim 12, wherein the integrated layer network is a backpropagation neural network.
